(19) United States
(12) Patent Application Publication
(10) Pub. No.: US 2009/0070241 A1
(43) Pub. Date: Mar. 12, 2009

(54) Bank balance funds check and negative balance controls for enterprise resource planning systems

(75) Inventor: Jagadish Chandra Manohar, Toronto (CA)

Correspondence Address: Manohar Enterprises, Inc., 219-508 Dawes Road, Toronto, ON, M4B 2G3, CA

(73) Assignee: MANOHAR ENTERPRISES, INC., Toronto (CA)

(21) Appl. No.: 12/228,188

(22) Filed: Aug. 11, 2008

Related U.S. Application Data
(60) Provisional application No. 60/967,912, filed on Sep. 7, 2007.

(51) Int. Cl. G06Q 10/00; G06Q 20/00

(52) U.S. Cl. 705/30

(57) ABSTRACT

A computer-implemented method, for enterprise financial systems, consisting of a set of controls, that checks if the existing bank balance funds available is adequate for each incoming transaction that requires or impacts such funds, and validates the transaction when there is adequate bank funds available, or fails validation when inadequate; and at the same time, accepts and processes incoming receipts, irrespective of whether or not there is adequate bank funds, to cover any negative receipts, even if resulting in or increasing the existing negative bank funds available, if any, and manages the situation arising there out of; as a result of which, the system prevents negative bank funds available, resulting or increasing, from outgoing payments against invoices, by way of, amongst others, restriction on the standard flexibility of fluctuation between positive and negative amounts, and at the same time, accepts all receipts, positive and negative, by way of, amongst others, context-sensitive exceptions to the restriction; including in situations with or without preauthorized credit limit or prepaid amount as the case may be.

### CROSS-REFERENCE TO RELATED APPLICATIONS

Provisional Application Number: U.S. 60/967,912; Filing Date: 07, Sept. 2007. Information herein modifies information in the Provisional Application.

### STATEMENT REGARDING FEDERALLY SPONSORED RESEARCH OR DEVELOPMENT

The subject of the invention is not part of work done for the United States Government or any of its Agencies. This is my original work. It resulted during 2004-2007, when I consulted the City of New York (NYC) Human Resources Administration (HRA) on its Oracle Financials Reconfiguration Project, through Adil Business Systems, Inc. (Adil). To my knowledge and understanding, I have signed Non-Disclosure-Nor-Compete Agreement with Adil but not signed any Work-made-for-Hire or equivalent agreement with or in favor of NYC, HRA, Adil or any other party.

### REFERENCE TO SEQUENCE LISTING, A TABLE, OR A COMPUTER PROGRAM LISTING COMPACT DISC APPENDIX, OR DRAWINGS

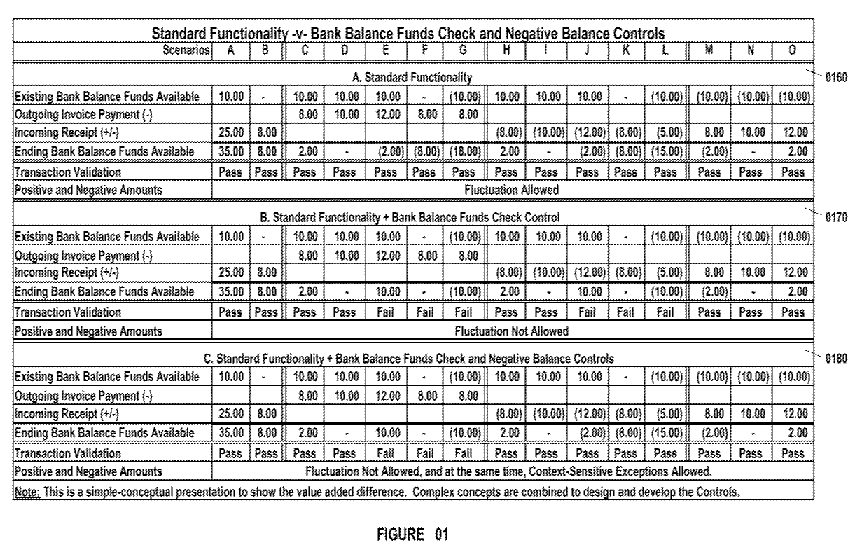

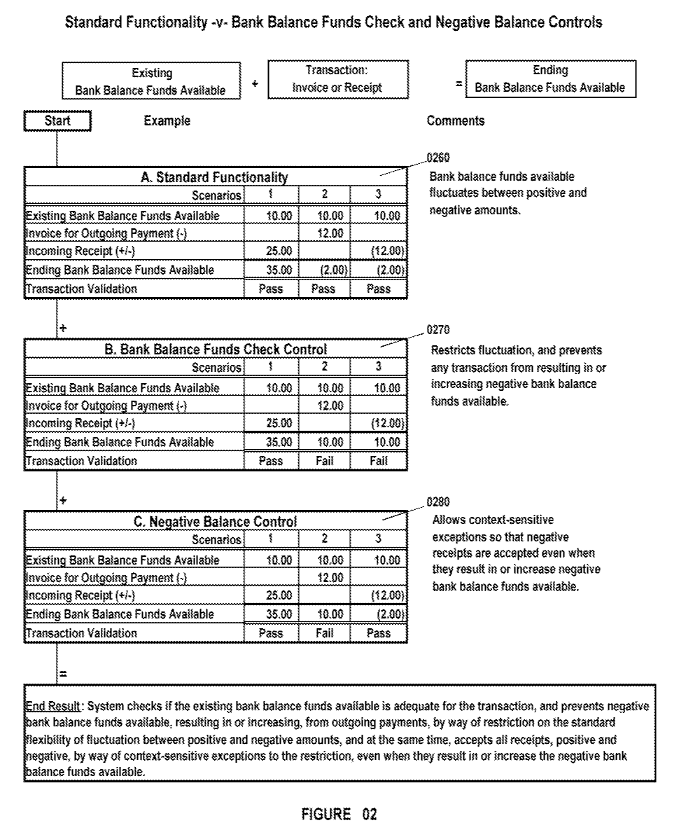

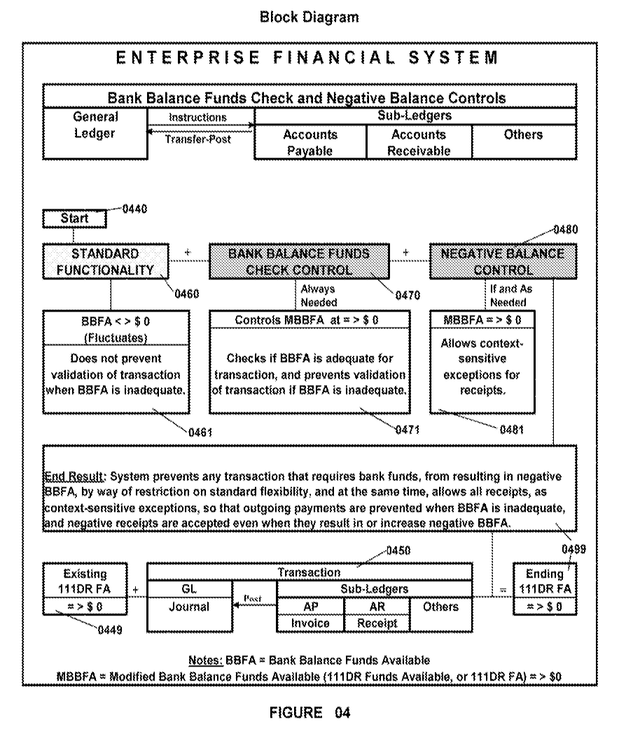

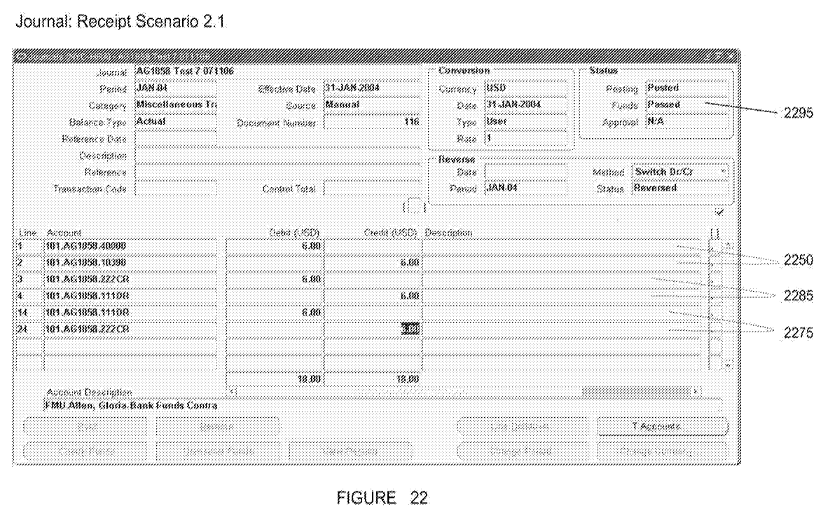

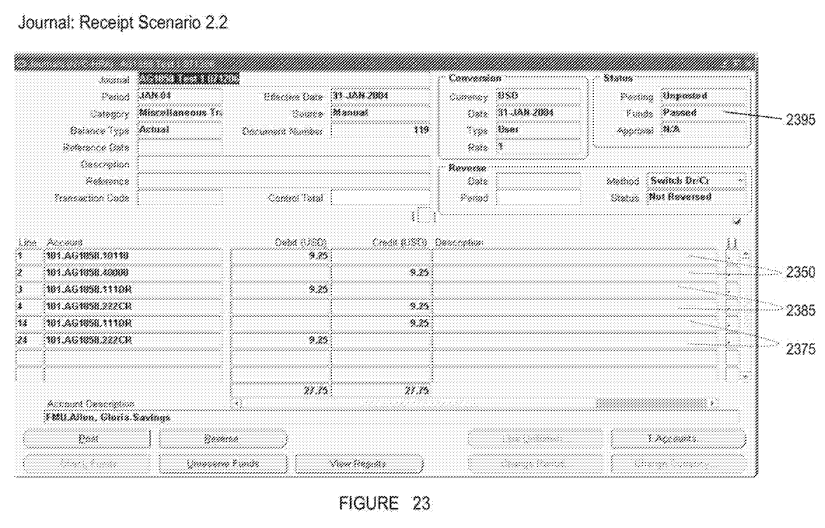

This invention is not in the nature of a visible piece, as it would be in the case of a mechanical item. The application does not involve any mechanical drawings or different views thereof, biological material, or sequence listing. The usefulness of the invention is in the nature of enhancing the currently available standard functionality of the mother system, and its enhanced value addition can be best seen by observing how the application's standard functionality works without the subject add-on Controls, and then with the Controls in place. To help understand the invention better, twenty four (24) Drawings, labeled as FIGS. 01 through 24, consisting of nine (9) Tables, four (4) Diagrams, and eleven (11) Screenshots are submitted, as listed herein below, as part of this nonprovisional application. FIGS. 01, 06 through 12 and 24 are Tables, 02 through 05 are Diagrams, and 13 through 23 are Screenshots. The drawings explain the high value added functionality of the subject Controls, the underlying subject matter principles, process flow and steps involved in developing and using the invention. Most of the drawings are too large to fit on one page, so they are compressed while taking the printouts. The large ones that are difficult to read on paper can be viewed better, in softcopy (PDF), using appropriate higher zoom, as needed. I suggest that FIGS. 02 and 04 together may accompany the abstract for publication.

### FIGURES

### Drawings (Tables, Diagrams and Screenshots)

01. Standard Functionality -v- Bank Balance Funds Check and Negative Balance Controls (Simple-Conceptual-Tabular)

02. Standard Functionality -v- Bank Balance Funds Check and Negative Balance Controls (Simple-Conceptual-Diagrammatic)

03. Additional Accounting Effects 1 and 2 (Detailed-Technical-Diagrammatic)

04. Block Diagram: Overview of Subject Controls within Enterprise Financial System

05. Process Flow Diagram: Development and User Steps

06. Customized Solution with Bank Balance Funds Check and Negative Balance Controls for Invoices: Distribution Account Expense or Prepayment (Detailed-Technical-Tabular)

07. Customized Solution with Bank Balance Funds Check and Negative Balance Controls for Invoices: Distribution Account Revenue (Detailed-Technical-Tabular)

08. Customized Solution with Bank Balance Funds Check and Negative Balance Controls for Receipts: Scenarios 1.1, 1.21 and 1.22 (Detailed-Technical-Tabular)

09. Customized Solution with Bank Balance Funds Check and Negative Balance Controls for Receipts: Scenarios 2.1, 2.21 and 2.22 (Detailed-Technical-Tabular)

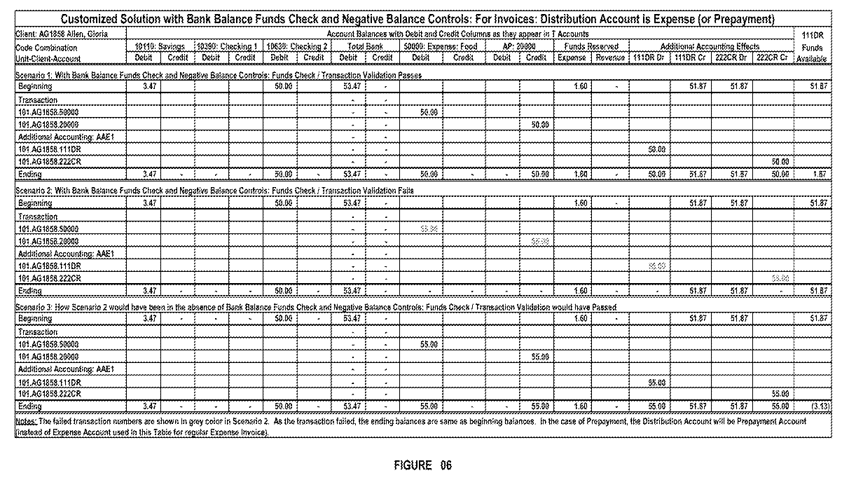

10. Brief Results of Standard Functionality -v- Subject Controls: For Examples in FIGS. 06, 07, 08 and 09 (Tabular)

11. A Real-Life, Full-Cycle Accounting Example (Tabular)

12. Controls used in Banks somewhat similar to Subject Invention (Tabular)

13. Referencing Transaction Code in AR Receipts Window

14. Referencing Transaction Code in AP Invoices Window

15. Referencing Transaction Code in AP Invoice Distributions Window

16. Entering Additional Accounting Effect 2 in AR Distributions Window

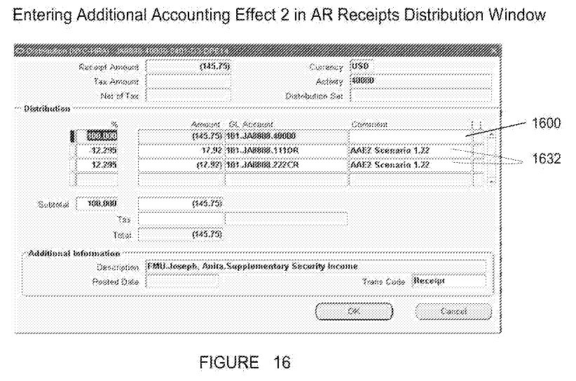

17. Journal for the Receipt in FIG. 16

18. Journal for Invoice All Scenarios

19. Journal for Receipt Scenario 1.1

20. Journal for Receipt Scenario 1.21

21. Journal for Receipt Scenario 1.22

22. Journal for Receipt Scenario 2.1

23. Journal for Receipt Scenario 2.2

24. Subject Controls as applicable to Credit and Prepaid Situations (Detailed-Technical-Tabular)

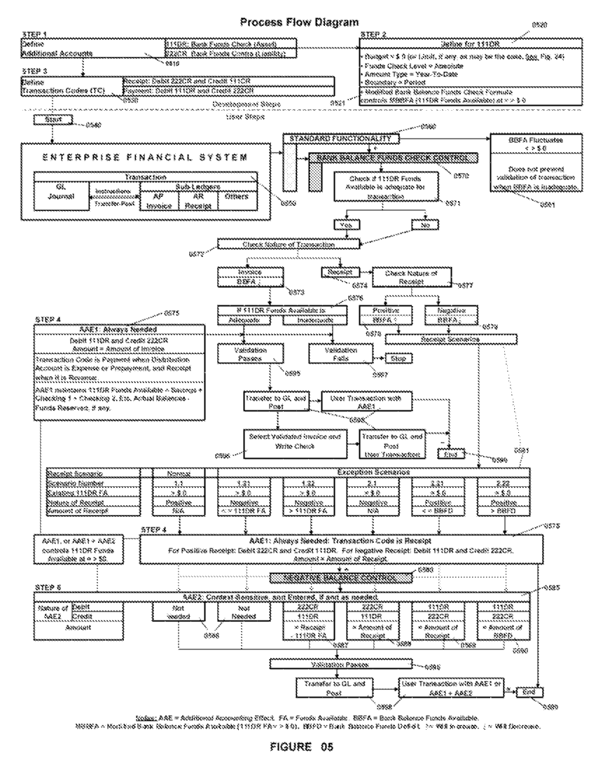

Main paragraphs in this Specification document are identified by 4-digit Arabic numerals with the first three or two digits being zeros like 0006 and 0028. Depending on the number of levels, the sub-paragraphs, if any, within a main paragraph are identified by lowercase English alphabets, lowercase roman numerals and bullets (solid or circular hollow) in that order. Key reference points on drawings are identified by 4-digit numerals in which the first two digits refer to the number of the Figure, and an effort has been made to assign the last two digits, in a way, coordinated, to the extent possible, amongst the different Figures, as to have the same concepts or steps, shown on different drawings, identified by the same last two digits. The reference numbers on FIGS. 04 and 05 are so assigned, to the extent and wherever possible, that they are not only coordinated with those on the other drawings, but the ascending order of the reference numbers on the said two drawings also indicates the general direction of flow of the various steps involved in developing and using the invention. Where it has not been possible to follow these guidelines, the reference numbers are assigned in some random order. References to Figures are identified herein in the Specification document within square parentheses like [1585]. The titles of the various drawings, as listed herein above, indicate whether a particular drawing is simple-conceptual or detailed-technical, and whether tabular or diagrammatic. While the simple-conceptual ones introduce the subject, the detailed-technical ones explain the invention in all its complexity with real-life examples, as entered, tested and demonstrated on the mother application.

### BACKGROUND OF THE INVENTION

The standard functionality of Enterprise Financial Systems does not prevent writing checks when there is inadequate bank balance funds available, in which case, the books result in negative bank funds. As we cannot issue checks with inadequate bank funds, we need to manually check the bank balance funds available each time we need to write a check so that it does not result in negative bank funds. This is very cumbersome, labor-intensive and risky, when multiple organization units, service areas, thousands of clients and bank accounts, large transaction volumes and frequent funds constraints are involved. To prevent this, many organizations maintain huge bank balances or have the overdraft facility. All these involve various costs and risks, operating, financial and procedural.

Negative bank funds are not possible in an ideal theoretical scenario, as we cannot pay, and should not write check, when there is no money in the bank account. But this is not so simple in the day-to-day practical life, and negative balances occur all the time. Negative bank funds may arise in two ways, by way of outgoing payment against invoice, and by way of incoming negative receipt, like Debit Memo or Credit Memo. All organizations may not have incoming negative receipts. While the incoming negative receipts could be non-controllable, in the sense the organization may not be able to control the inflow of Debit/Credit Memos, the outgoing payments are controllable, in the sense the organization can holdback the payments for any reason including inadequate bank funds. Accordingly, user organizations need to have the ability to prevent writing checks when the available bank funds is inadequate, thus preventing negative bank funds resulting from outgoing payment against invoice, and at the same time allow negative bank funds as a result of incoming negative receipt. From a practical control perspective, the best way to prevent an outgoing payment against invoice is to do it before it reaches the check writing stage. The subject invention addresses these high value added needs of the user community.

Enterprise Resource Planning Applications, or ERP Systems, or as referred to herein, the Enterprise Financial Systems, are usually organized into a number of product areas like Financials, Manufacturing, Projects, Human Resources, Procurement, Supply Chain Management and Customer Relationship Management, with each of these areas consisting of individual application modules. The Financials area consists of the most used modules like General Ledger (GL), Accounts Payable (Payables, or AP), Accounts Receivable (Receivables, or AR), Assets and Cash Management. All the sub ledgers in an enterprise, wherever financial transactions are involved, post into the General Ledger, and General Ledger is the sum total of all financial/accounting information. Adequate checks and balances and controls are a must for any organization. While some controls reside in the General Ledger, some reside in the appropriate sub ledgers. In cases where the controls reside in the General Ledger, their impact may well transcend across the sub ledgers.

### BRIEF SUMMARY OF THE INVENTION

The Bank Balance Funds Check and Negative Balance Controls are high value added controls, developed on top of the standard functionality of the Enterprise Financial System. The Bank Balance Funds Check Control checks the available bank funds each time there is an invoice to pay and validates it only if there is adequate bank funds, and if not, the invoice validation fails. As only validated invoices can be selected for payment, the unvalidated invoices do not reach the check writing stage, and as such, are prevented from being paid. On the other hand, the Negative Balance Control allows the processing of negative receipts even when they result in or increase the negative bank funds. The manual intervention, required in the absence of these Controls, is not needed when we have these add-on Controls in place.

As the title of the invention says, the subject invention has two key component Controls. (a) The Bank Balance Funds Check Control checks if the existing bank funds available is adequate for the transaction, and prevents writing check against invoice when there is inadequate bank funds, and (b) the Negative Balance Control allows processing of negative receipt even when it results in or increases the existing negative bank funds. The standard Oracle Financials functionality is built with the flexibility of (account balances and) bank funds available fluctuating between positive and negative amounts, and does not prevent writing check when the bank funds available is inadequate. I believe that the other ERP Systems are also built similarly. While the Bank Balance Funds Check Control is developed as restriction on this standard flexibility, the Negative Balance Control is developed as context-sensitive exceptions to the restriction.

Depending on the need of a user organization, it is possible to have either the Bank Balance Funds Check Control on a stand-alone basis, or the Bank Balance Funds Check and Negative Balance Controls together. But for practical considerations, both Controls are needed in almost all cases, and I would not normally advise any organization using the former on stand-alone basis, as such usage would require, as a pre-condition, total and absolute absence of incoming negative receipts, which may not be the case in reality. The Negative Balance Control complements the Bank Balance Funds Check Control, and the combined result is what most of the user organizations need. Implementing both the Controls is obviously more complex than implementing one of them. The Controls can be implemented to various degrees of automation. When fully automated, it avoids the manual intervention totally. These add-on Controls, on top of the standard application functionality, are the subject matter of this application.

FIG. 01 introduces the subject and shows, in simple-conceptual terms, how the standard functionality of the mother application, as currently available in the market place, works [0160], and compares it with, first the add-on functionality that the Bank Balance Funds Check Control provides on standalone basis [0170], and then the combined value addition that the Bank Balance Funds Check and Negative Balance Controls together provide [0180], to the enterprise. While FIG. 01 explains the Standard Functionality -v-Standard Functionality+Subject Controls, in tabular form, FIG. 02 explains the same [0260, 0270 and 0280] through a simple-conceptual diagrammatic presentation.

### DETAILED DESCRIPTION OF THE INVENTION

On my City of New York, Human Resources Administration (HRA)'s Oracle Financials Reconfiguration Project, where the subject invention materialized, HRA has multiple organization units or service areas and 1,000s of City resident Clients, growing every month, each client a full-fledged balancing entity with multiple bank accounts, different accounts designated for different purposes, money in special purpose accounts not to be used for day-to-day payments, many payments per client per month, frequent funds constraints, and invoice should be paid irrespective of whether there is adequate amount in the designated payment account or not as long as the combined uncommitted balance, in all the bank accounts not designated for any special purposes, is adequate. For a user organization like HRA, these Controls are very critical and essential, as much as they can be called the backbone of the implementation. The HRA project is a single organization unit, single currency and single set of books implementation, with a large client base. Using the same design concepts, we can implement the subject Controls for any organization or enterprise, of any size, complexity of organization structure, number of organization units, service areas and clients, number of bank accounts, designated purposes of the bank accounts and volume of transactions, and the Controls would work the same way and achieve the same goals.

### Technical Design and Development

The first objective of the invention is that invoice should not be paid if the bank funds available (combined balance in all the applicable general purpose bank accounts like Savings, Checking 1, Checking 2, etc. to the extent not reserved) is less than the invoice amount. The underlying principle here is that any transaction that requires bank funds should not be validated when the available bank funds is inadequate to cover that transaction. Invoice should be paid irrespective of whether there is adequate balance or not in the designated payment account (example: Checking 2) as long as there is adequate funds available, avoiding the need to transfer amount to the designated payment account from other accounts whenever there is an invoice to pay, there is no adequate balance in the designated payment account but there is adequate bank funds available. The Bank Balance Funds Check Control achieves these needs, by way of, amongst others, restriction on the standard flexibility. The second objective is that when a negative receipt comes-in, the system should process it even if it were to result in or increase the existing negative bank funds available. The Negative Balance Control achieves this need, by way of, amongst others, context-sensitive exceptions to the restriction.

The subject invention has been developed by combining a number of financial-accounting (like double entry system of bookkeeping, journal entry, budgeting, budgetary control, funds check and encumbrance) and systems development principles, disparate standard application features and custom programming, through a complex design, in a unique way, to achieve the unique, non-standard, high value added, critical user needs.

The subject invention has been achieved, by way of, amongst others, additional accounting effects, of normal transactions like Invoice, Receipt and Journal that result in increase or decrease of bank funds, in a way the system performs the normal user task as usual, and at the same time, creates additional accounting effect or effects, as needed, depending on the details of existing bank funds available and the incoming transaction. Controls are applied on the appropriate custom-developed components of the additional accounting effect or effects, which in turn, triggers an appropriate preventive control on the concerned user transaction (in the case of invoice) before the transaction takes place (control is exercised at the invoice validation stage before the invoice reaches the check writing stage), or allows it as a context-sensitive exception to the restriction (in the case of receipt).

The whole invention is described herein in five main steps, and sub-steps within those main steps, as needed. The first three steps are more in the nature of one-time steps so may be called Development Steps, and the next two steps are used, as needed, each time there is a user transaction that impacts the bank funds available so may be called the User Steps. I have used Step 3, in Oracle Financials, for the purpose of facilitating Step 4, and as such its scope and usage could differ in different ERP Systems depending on how those systems are built. While Step 4 is always needed, in the case of both outgoing payments against invoices and incoming receipts, Step 5 is used, if and as needed, in the case of incoming receipts only.

### Step 1: Additional Accounts [0510]

We define two Additional Accounts (non-user-used) (5-digit accounts are used in this example):

a. 111 DR: Bank Funds Check (defined as Asset, Debit Balance normally)

b. 222CR: Bank Funds Contra (defined as Liability, Credit Balance normally)

### Step 2: Definitions for 111 DR Account [0520]

For the 111DR account, we define the following Budgetary Control: Budget: Entered; Funds Check Level: Absolute; Amount Type: Year-To-Date (YTD); and Boundary: Period; and enter $0 budget for all Periods. The system will presume $0 budget when we don't enter the budget amount. Absolute means the transaction must always pass the funds check test. Otherwise, the transaction fails. This is very important here, as a component of the Bank Balance Funds Check Control. Amount Type of YTD and Boundary of Period are suitable when we have yearly calendar with monthly periods.

Oracle standard functionality uses the following Funds Check formula:

Funds Available in an Account=Budget−(Actual+Encumbrance).

As against this, the Bank Balance Funds Check Control uses the following two-part Modified Bank Balance Funds Check formula for the 111 DR Account [0521]:
a. When the Savings+Checking 1+Checking 2, etc. Actual Balances−Funds Reserved, if any, is >=$0:
   111 DR Funds Available=Savings+Checking 1+Checking 2 Actual Balances−Funds Reserved, if any; and
b. When the Savings+Checking 1+Checking 2, etc. Actual Balances−Funds Reserved, if any, is <=$0:
   111 DR Funds Available=0.

### Step 3: Account Code Pairs or Transaction Codes [0530]

We define two Account Code Pairs, or Transaction Codes, Receipt and Payment, and attach the Additional Accounts to each of them as follows:

a. Receipt: Debit 222CR and Credit 111 DR

b. Payment: Debit 111 DR and Credit 222CR

### Step 4: Additional Accounting Effect 1 (AAE1) [0375 and 0575]

When a user transaction like AP Invoice or AR Receipt, or GL Journal is processed that impacts the Bank Balance Funds Available, additional accounting effect, AAE1 is (or effects, AAE1 and AAE2 are) entered, as needed.

Whenever there is a user transaction that increases the bank balance funds available, we enter an equal Credit to 111 DR (and Debit to 222CR). Examples: Opening Balances and Receipts (positive amounts).

Whenever there is a transaction that decreases the bank balance funds available, we enter an equal Debit to 111 DR (and Credit to 222CR). Example: Invoices for outgoing payments, and Receipts (negative amount)

Bank Balance Funds Check Control prevents transactions that do not meet the modified bank balance funds check requirement. Additional Accounting Effect 1 (together with AAE2 where so needed) maintains the 111 DR Funds Available equal to the combined bank balance less funds reserved, if any [0375 and 0575], and the absolute control on 111 DR prevents validation of transaction when the bank balance funds available is inadequate [0521]. The amount of the Additional Accounting Effect 1 is always equal to the amount of the user transaction. Every user transaction that increases or decreases the bank balance funds available will reference the appropriate Transaction Code as follows:
a. In General Ledger: During Journal Entry: At the Line level for the required lines.
   i. Receipt for transactions that increase the Bank Balance Funds Available
   ii. Payment for transactions that decrease the Bank Balance Funds Available
b. In Payables: During Invoice Entry: At the Header level for the entire Invoice.
   i. Payment for invoices where all the Distribution Accounts of the invoice are Expense (or Prepayment) Accounts
   ii. Receipt for all invoices where all the Distribution Accounts of the invoice are Revenue Accounts.
   iii. In the event some of the distribution lines are Expense accounts and some are Revenue accounts in the same invoice (very rare, or almost not there in reality), then in such cases, the appropriate Transaction Codes are referenced on each of the Distribution Lines on the Distributions window, as needed, not in the Invoice Header. When the Transaction Code is referenced in the Invoice Header block, it defaults to all the Distribution Lines in the Distributions window, where it can be changed, if and as needed.
c. In Receivables: During Receipt Entry: At the Header level for the entire Receipt.
Receipt for all receipts, both positive and negative amount receipts.
d. Referencing the Transaction Code at the Batch Header is not advised whether it is GL Journal, AP Invoice or AR Receipt.
e. The subject invention has used the oracle standard feature of Transaction Code to enter the Additional Accounting Effect 1. When we use the Transaction Code, we do not enter the additional accounting effect. Instead, we reference the appropriate Transaction Code in the user transaction, and the mother system automatically generates the needed additional accounting effect, depending on the Transaction Code used, in conjunction with the standard functionality of the mother system in relation to the particular user task being performed.
f. In the case of Prepayment, a Prepayment Account is used, instead of an Expense Account in the case of regular Expense Invoice. Referencing the Transaction Code in the case of Prepayment, for the purpose of AAE1, is same as followed in the case of Expense Invoice.
g. When a DebitCredit Memo needs to be processed in Accounts Payable, it is an adjustment (reduction) against a pre-entered Invoice. A DebitCredit Memo adjusts (reverses) the effect of the pre-entered additional accounting effect to the same extent as the invoice is adjusted, before payment is made against the invoice.
h. Transaction Code, as described herein, should not be referenced in user transactions that do not increase or decrease the bank balance funds available. Example: Transfer from one bank account to another (say, from Savings to Checking 2). Checking 2 is mentioned here with the premise that it is the designated payment account. It can be any one or more accounts, as needed. The design concepts are the same. In case an ERP System does not have the Transaction Code feature, we need to enter the Additional Accounting Effect 1.
i. In the case of Receipts, we reference the Transaction Code, Receipt, and the system generates the Additional Accounting Effect 1 (Credit or Debit 111 DR), as needed, depending on whether the incoming receipt is positive or negative.

### Step 5: Additional Accounting Effect 2 (AAE2) [0385 and 0585]

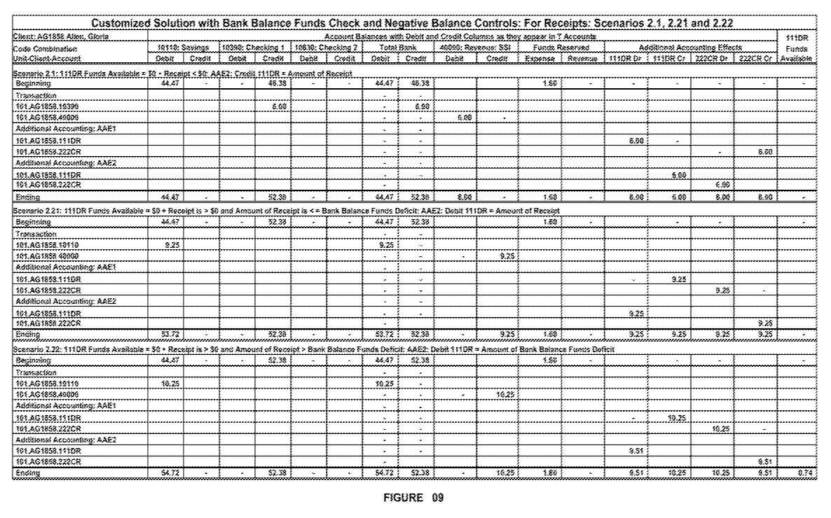

Additional Accounting Effect 2 is used, amongst others, to allow processing of negative receipts even when they result in or increase the existing negative bank funds available. AAE2 is not always needed. When needed, it is used in addition to AAE1, to allow negative bank balance funds and manage the situation arising there out of, in conjunction with the ability to prevent validation of transaction when the bank funds available is inadequate to cover the transaction. Whether AAE2 is needed or not, as well as the nature and amount of AAE2 are context based, and when needed, the amount is calculated depending on the existing and incoming criteria, as applicable, per scenarios discussed below:
a. Scenario 1.1[0586]: If the Existing 111DR Funds Available is Positive (>$0) and the Incoming Receipt is Positive (>$0): Additional Accounting Effect 2: Not needed.
b. Scenario 1.21[0586]: If the Existing 111DR Funds Available is Positive (>$0), the Incoming Receipt is Negative (<$0) and the Amount of the Incoming Negative Receipt is <=Existing 111 DR Funds Available: Additional Accounting Effect 2: Not needed.
c. Scenario 1.22[0587]: If the Existing 111 DR Funds Available is Positive (>$0), the Incoming Receipt is Negative (<$0), and the Amount of the Incoming Negative Receipt is > Existing 111 DR Funds Available: Additional Accounting Effect 2: Debit 222CR and Credit 111 DR, equal in amount, to the Amount of Incoming Negative Receipt less Existing 111 DR Funds Available.
d. Scenario 2.1[0588]: If the Existing 111 DR Funds Available is =$0 and the Incoming Receipt is Negative (<$0): Additional Accounting Effect 2: Debit 222CR and Credit 111 DR, equal in amount, to the Amount of the Incoming Negative Receipt.
e. Scenario 2.2[0589 and 0590]: If the Existing 111 DR Funds Available=$0 and the Incoming Receipt is Positive (>$0): Additional Accounting Effect 2: Debit 111 DR and Credit 222CR, equal in amount, to the Amount of the Incoming Receipt or Existing Bank Balance Funds Deficit, whichever is less.
f. For the purpose of better understanding, in FIG. 09, Scenario 2.2 is shown with two Sub-Scenarios 2.21[0589] and 2.22[0590].
g. Amount referred to herein, means the absolute amount without reference to plus or minus sign associated with it, unless otherwise specifically mentioned.

If any transactions that increase or decrease the bank funds available, originate in any sub-ledger other than Payables and Receivables, then such transactions would need the additional accounting effect or effects the same way as described herein. Payables and Receivables windows of the mother application usually have provision to reference Transaction Code and enter Additional Accounting Effect 2 as described herein. In case the originating sub edger, or the ERP System, does not have such features or provisions, the required additional accounting effects may have to be entered directly in the General Ledger. The additional accounting effects must be validated latest along with the user transaction.

While FIGS. 02 through 05 explain the subject Controls diagrammatically, FIGS. 06 through 12 give details of the custom-solution with real-life, full-cycle examples, as entered and tested on the mother application.

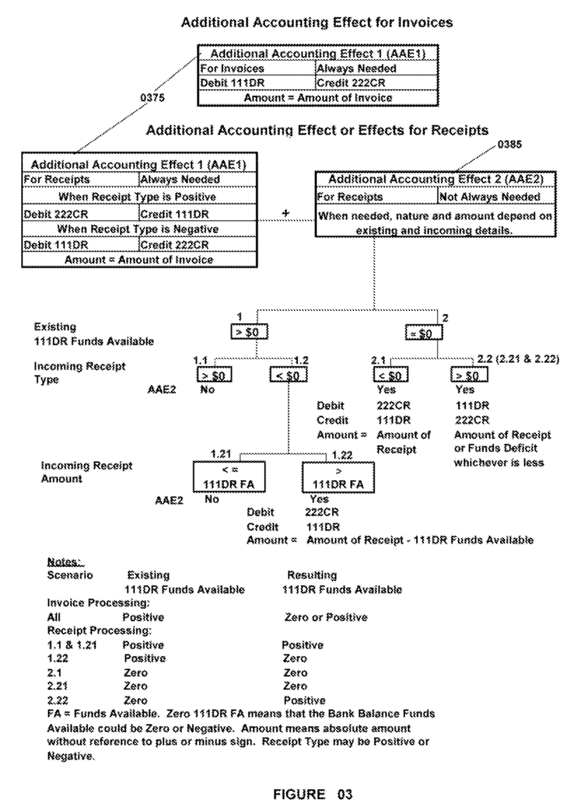

FIG. 03 explains, diagrammatically, the Additional Accounting Effects. 1 and 2, in detailed-technical terms, and how AAE1 is used in relation to invoice processing for outgoing payments, and either AAE1 is, or AAE1 and AAE2 are used in relation to different receipt scenarios [0375 and 0385].

While the Block Diagram in FIG. 04 gives an overview of the subject Controls within the Enterprise Financial System, the Process Flow Diagram in FIG. 05 details the subject in all its complexity, in terms of how the Controls have been envisioned, designed and developed, how they are used in normal user transactions, how they add enhanced utility value to the day-to-day work processes, and indicate the direction of flow of the various steps involved.

The subject Controls deal with user transactions that affect the bank balance funds available [0450 and 0550]. The user transactions of Receipts and Invoices, that increase or decrease the bank balance funds available, normally originate in Accounts Receivable and Accounts Payable modules, and after being validated there, are transferred to and posted in the General Ledger, based on instructions, if any, from the General Ledger that transcends across the enterprise, as appropriate. The Block and Process Flow Diagrams depict the various steps involved between Start [0440, 0449 and 0540] and End [0499 and 0599]. While some steps are handled by the mother system or user-decided, what is important for the purpose of this discussion is what the subject Controls do in addition to what the mother application otherwise normally does, and the value added difference they make to the work processes. The Standard Functionality [0460 and 0560] of the Enterprise Financial Systems are built with the flexibility of (account balances and) bank balance funds available fluctuating between positive and negative amounts, and does not prevent writing check when the bank balance funds available is inadequate [0461 and 0561]. As against this, the Bank Balance Funds Check Control [0470 and 0570] kicks-in in the case of all transactions that require or impact the bank balance funds available, by way of checking to see if the existing bank balance funds available is adequate for the transaction being processed, and prevents validation of any transaction when the bank balance funds available is inadequate, by way of restriction on the standard flexibility: [0471, and 0571 and 0597]. On the other hand, the Negative Balance Control [0480 and 0580] kicks-in in the case of receipts, and allows negative receipts, even when they result in or increase the negative bank funds, by way of context-sensitive exceptions to the restriction [0481]. The following paragraphs discuss the various steps involved in more detail.

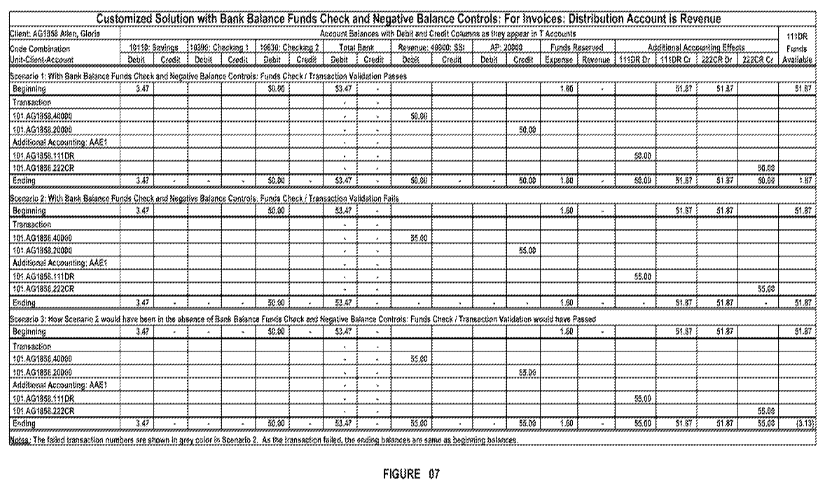

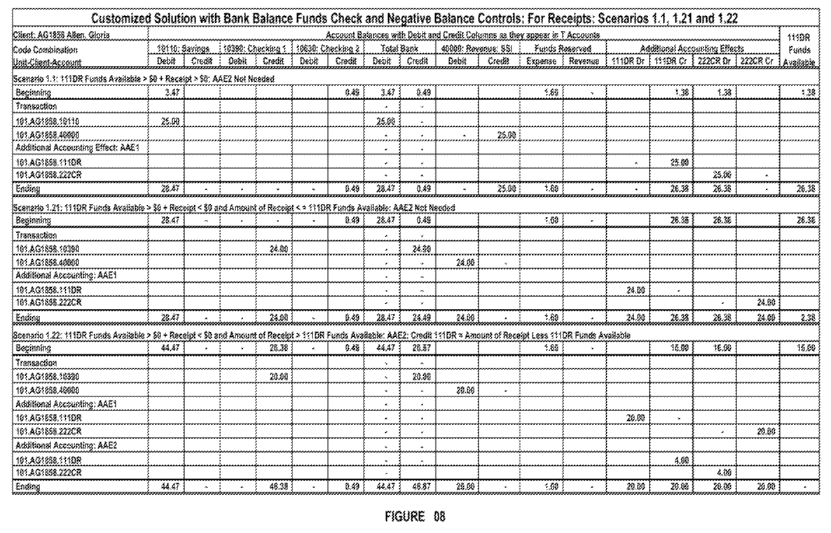

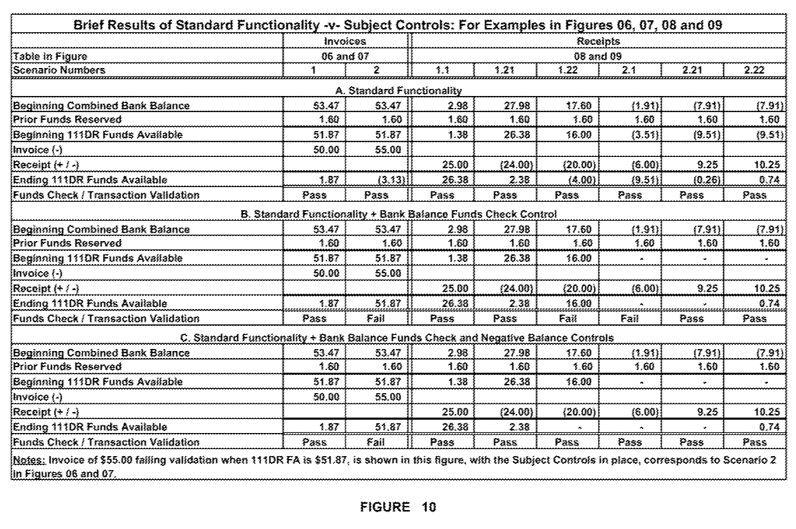

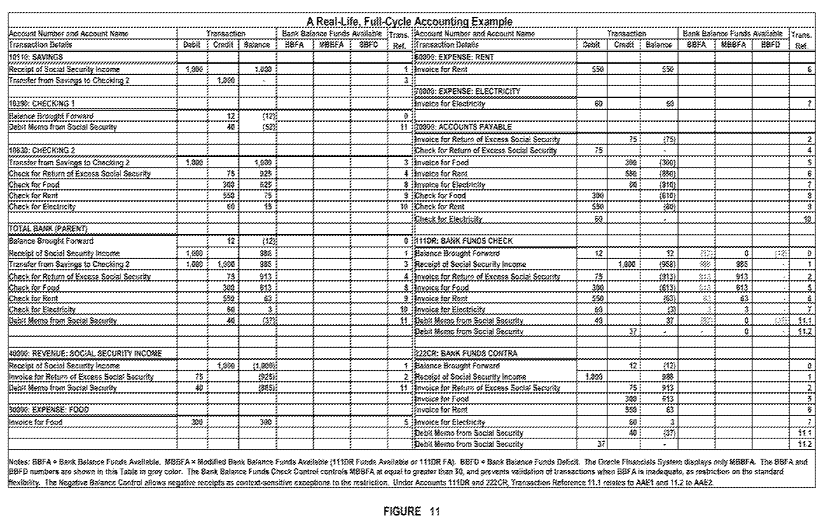

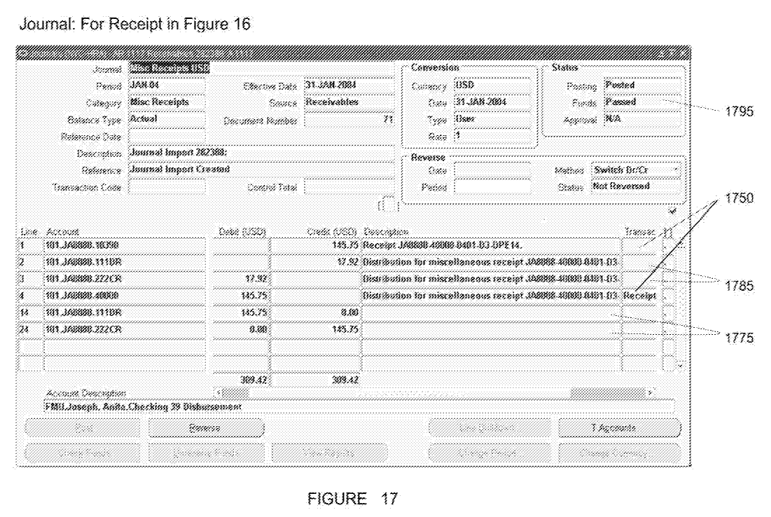

FIGS. 06 and 07 explain the customized solution, in detailed-technical terms, how the subject Controls work and add value, in relation to Invoice processing, 06 when the Distribution Account is Expense (or Prepayment) and 07 when it is Revenue. FIGS. 08 and 09 explain the customized solution, in detailed-technical terms, in relation to Receipt processing, 08 in relation to Receipt Scenarios 1.1, 1.21 and 1.22, and 09 in relation to Receipt Scenarios 2.1, 2.21 and 2.22. FIGS. 06 through 09 explain the details of the Additional Accounting Effect or Effects involved, under what circumstances either or both are used, as well as account balances and bank funds available before and after the particular transaction, based on examples used. FIG. 10 shows the Brief Results of Standard Functionality -v- Standard Functionality+Subject Controls for the examples used in FIGS. 06 through 09. FIG. 11 is a full-cycle example, showing the accounting involved for a full monthly cycle, for the normal user tasks and the related Additional Accounting Effects. FIGS. 17 through 23 show journal entries for the normal user transactions and the related Additional Accounting Effects 1 and 2, when the subject Controls are in place. In the absence of the subject Controls, we would have seen only two journal lines per transaction, as against four journal lines when only AAE1 is involved, or six lines when both AAE1 and AAE2 are involved, for a normal user transaction like invoice or receipt of one line item, as we now see on these Screenshots.

As described above, the subject Controls are achieved by defining (a) two Additional Accounts, 111 DR and 222CR, of which, the standard Funds Available on the former is controlled and maintained at equal to the combined bank balance less funds reserved, if any, when the same is positive or at $0 when it is zero or negative, and (b) Funds Check Level of Absolute on 111 DR, and (c) entering Additional Accounting Effect 1 or a combination of Additional Accounting Effects 1 and 2, involving the said two Additional Accounts, as appropriately needed, for all transactions that impact the bank funds.

In FIGS. 08 and 09, dealing with processing of receipts, while Scenario 1.1 is the most Normal Receipt Scenario in which the Existing 111 DR Funds Available and the Incoming Receipt are both positive and results in positive 111 DR Funds Available, Scenarios 1.21, 1.22, 2.1, 2.21 and 2.22 are the Exception Scenarios, each of which, requires a different, context-sensitive treatment in relation to whether AAE2 is needed, and if so, the exact nature and amount of AAE2 needed. While Scenarios 1.1, 1.21 and 1.22 deal with positive Existing 111DR Funds Available, Scenarios 2.1, 2.21 and 2.22 deal with zero Existing 111 DR Funds Available, and while Scenarios 1.21, 1.22 and 2.1 deal with negative receipts, Scenarios 2.21 and 2.22 deal with positive receipts.

As part of the Bank Balance Funds Check Control [0470 and 0570], AAE1 maintains the 111 DR Funds Available equal to combined bank balance less funds reserved, if any [0575], and at the same time, the absolute control on 111 DR maintains the 111 DR Funds Available equal to or greater than $0 and prevents it from becoming negative [0521]. With these requirements and/or restrictions in place, when we allow processing of negative receipts with inadequate bank funds available, it is against the requirement of the Bank Balance Funds Check Control, so creates a series of exception scenarios, depending on the Existing 111 DR Funds Available and the incoming receipt details [0581]. The Negative Balance Control [0480 and 0580] addresses these exception scenarios and manages the situation arising there out of, by way of context-sensitive Additional Accounting Effect 2 [0585, read with, 0586 through 0590]. The Negative Balance Control has been tested and fool-proofed for all possible exception scenarios. The Negative Balance Control is needed because of the restriction the Bank Balance Funds Check Control places on the system. For this reason, the Negative Balance Control is not needed, nor can be implemented, on a stand-alone basis, in the absence of the Bank Balance Funds Check Control.

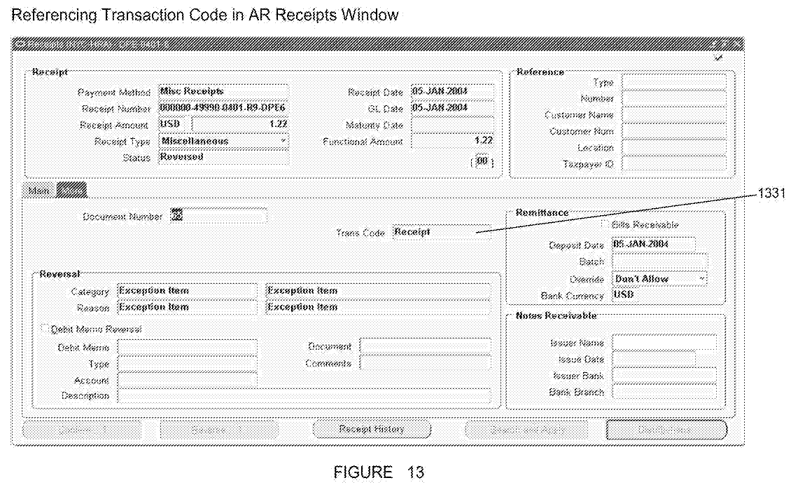

The Development Steps and the User Steps of Additional Accounting Effects 1 and 2, read with the related Tables in FIGS. 01 through 11, Diagrams in FIGS. 02 through 05 and Screenshots in FIGS. 13 through 23, explain the objectives, the underlying subject matter principles, the steps involved in developing the subject Controls and how they add value to the day-to-day work processes, with real-life examples, as entered and tested on the mother system. No single Drawing gives the full details, and each of them needs to be looked at in conjunction with related descriptive text herein and other related Drawings.

FIG. 11 shows a real-life, full monthly accounting cycle, for the user transactions, along with the related additional accounting effects involved, and how the additional accounting effects control the user transactions and add value. It is to be noted here that had the Invoice for Electricity been any amount greater than $63 instead of $60 (Trans. Ref. 7), that invoice would have failed the funds check validation, because of Bank Balance Funds Check Control. It is also to be noted that at the time of the Debit Memo of $40 from Social Security (Trans. Ref. 11), the bank funds available of $3 is inadequate to cover the transaction but still the system validated this transaction, because of the Negative Balance Control. Had it been an invoice instead of debit memo, the system would not have validated it. This difference is key to the subject Controls. The system displays only the Modified Bank Balance Funds Available (MBBFA or 111 DR Funds Available) numbers. At the end of the said debit memo of $40, it is to be noted that the system has 111DR Funds Available of $0 (meaning there is no bank funds to pay any new invoices) and a Bank Balance Funds Deficit (BBFD) of ($37). The bank balances at this time are $0 in Savings, ($52) in Checking 1 and $15 in Checking 2, the combined bank balance thus being ($37) and there is no funds reserved at this time. The Oracle Financials system does not display BBFD, but the Negative Balance Control calculates and uses it to enter the appropriate AAE2 when there is a receipt Scenario of 2.21 or 2.22. BBFD of ($37) is what the mother system would have shown for 111 DR FA, per standard Oracle Funds Check formula, in the absence of the subject Controls. This explains how each of the individual development and user steps adds value to the overall objectives. In FIG. 11, MBBFA is shown in black color while the BBFA and BBFD are shown in gray color, to indicate that it is only MBBFA that the system displays.

During transaction entry, we can manually reference the required Transaction Code or automate it. When fully automated, the system would automatically reference the required Transaction Codes. When the Transaction Code is referenced, the system generates the corresponding journal entry for AAE1. Manually referencing the Transaction Code is not difficult, as the design requires AAE1 always for any transaction that increases or decreases the bank funds available and the amount of AAE1 is always equal to the transaction amount. We can manually enter AAE2 as well, but doing so is rather difficult, if not impossible. AAE2 is not always required, the calculation is complex, time-taking, and differs for each exception scenario, so entering it manually is risky, and could easily lead to mistakes, so not advised. To avoid such risks, add value through process efficiencies, and improve overall productivity, AAE2 should be completely automated. In a customized solution, this can be achieved through appropriate data-load scripts that automatically reference the required Transaction Code for AAE1 and enter the AAE2, if and as required, whether the transaction entry is manual or automated through batch loads or comes-in from feeder systems via interfaces.

As a result of the subject Controls, the 111 DR Funds Available is always kept equal to or greater than $0, equal to the combined bank balance less funds reserved, if any, when it is positive, and equal to $0 when the combined bank balance less funds reserved, if any, is zero or negative [0521, 0575 and 0585]. The Controls are so implemented that when fully automated, they work the same way irrespective of whether the transaction entry is done manually, or automated, and automatically trigger the appropriate additional accounting effect or effects for the AP Invoice and AR Receipt or GL Journal entries, or for that matter, as may be needed, for transaction entries in other sub-ledgers that impact the bank funds available. The combined practical result of the Bank Balance Funds Check and Negative Balance Controls working together is that the system prevents negative funds available resulting from outgoing payment against invoice, or any transaction for that matter, when the bank funds available is inadequate, and at the same time, allows negative receipt even if it were to result in or increase the negative bank funds available [0499].

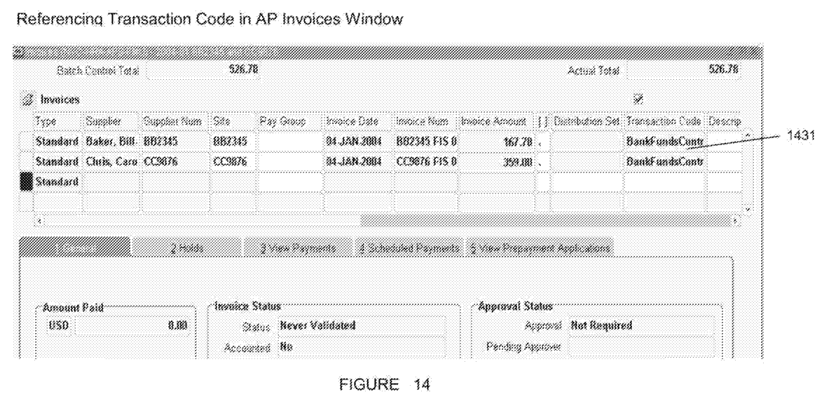

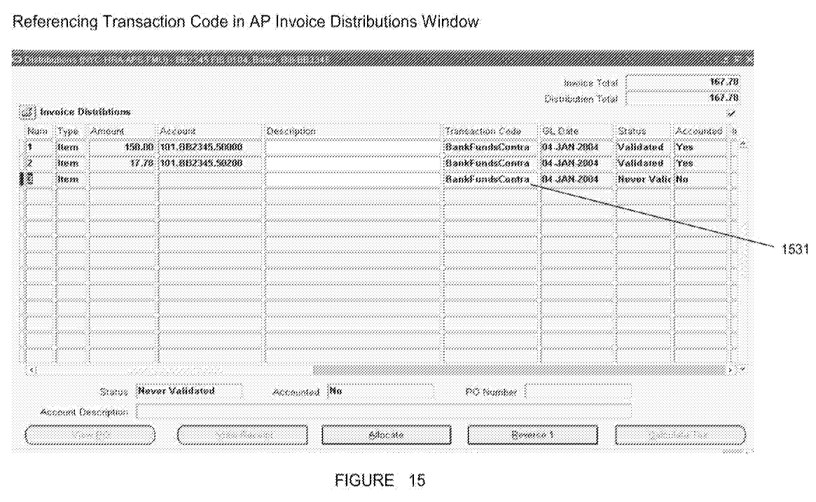

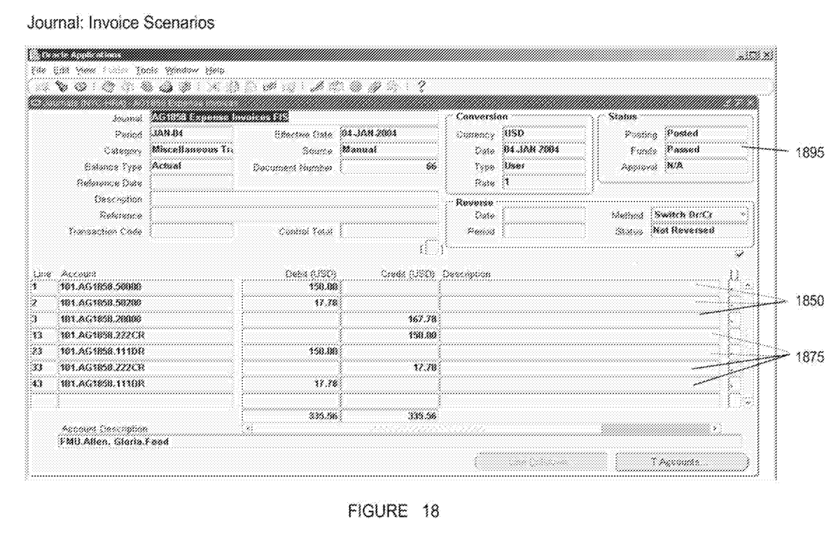

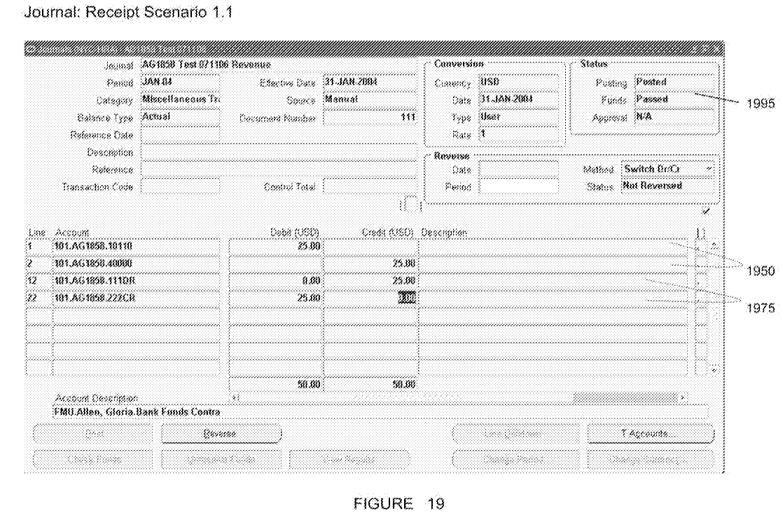

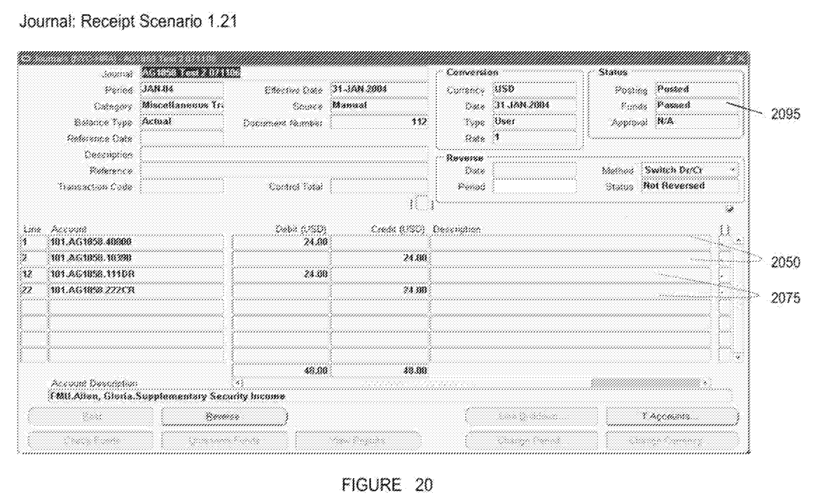

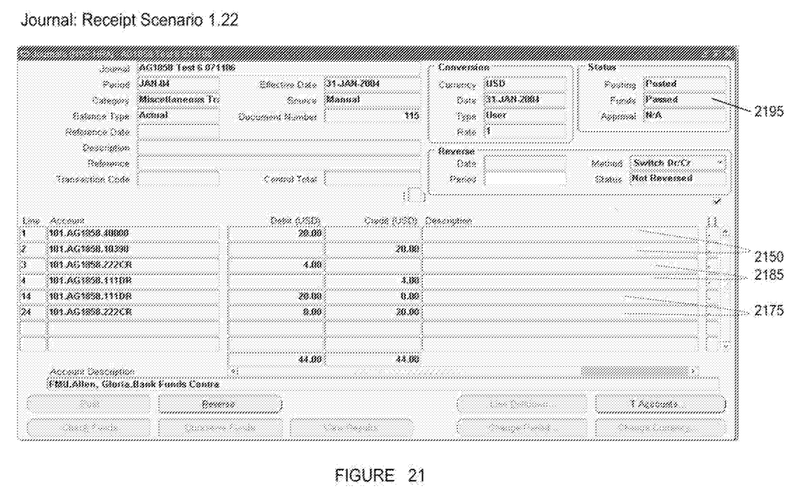

FIG. 13 shows how the Transaction Code is referenced in the AR Receipts window [1331]. FIG. 14 shows how the Transaction Code is referenced in AP Invoices window [1431]. The Transaction Codes of Receipt and Payment, on the HRA project, were earlier defined as BankFundsContra and BankFundsCheck. FIG. 15 shows how the Transaction Code, referenced in the AP Invoices window, defaults to the AP Distributions window, where it can be changed, if and as needed [1531]. While FIG. 16 shows how the Additional Accounting Effect 2 is entered in AR Receipt Distributions window [1632], as appropriately needed for the underlying receipt transaction [1600], FIG. 17 shows how the AAE2 entered in FIG. 16 translates into the required journal entry for the receipt, AAE1 and AAE2 [1750, 1775 and 1785]. It is to be noted here that a positive amount entered for 111 DR in the Receipt Distributions window translates into crediting that account in the Journal and a negative amount into debiting that account [1632 and 1785], similar to the Revenue Account of 40000 being debited [1750] for a negative receipt [1600]. If it had been a positive amount receipt, the Revenue account would have been credited. FIG. 18 shows the AAE1 Journal Lines [1875] as appropriately needed for the Invoice transaction therein shown [1850]. The AAE1 for all Invoice and Prepayment scenarios will be this way. FIGS. 19 and 20 show the AAE1 Journal Lines [1975 and 2075] as appropriately needed for the Receipt Scenarios 1.1 and 1.21 therein shown [1950 and 2050]. FIGS. 21, 22 and 23 show the AAE1 and AAE2 Journal Lines [AAE1: 2175, 2275 and 2375, and AAE2: 2185, 2285 and 2385] as appropriately needed for the Receipt Scenarios 1.22, 2.1 and 2.2 therein shown [2150, 2250 and 2350]. Invoice and Prepayment scenarios have only AAE1. Normal Receipt Scenario 1.1 and Exception Receipt Scenario 1.21 also have only AAE1. Exception Receipt Scenarios 1.22, 2.1 and 2.2 have both AAE1 and AAE2. FIGS. 17 through 23 show the Journal Entries that the system generates for the underlying Invoice and Receipt transactions, when the subject Controls are in place, with details as to the exact nature and amount of the Additional Accounting Effect or Effects and which of the Journal Lines correspond to the Invoice or Receipt transaction and which Lines correspond to the related AAE1, or AAE1 and AAE2. The Status block of the Journal window of the mother application shows whether the Invoice or Receipt transaction has passed or failed the Funds Check [1795, 1895, 1995, 2095, 2195, 2295 and 2395] and also whether the journal is posted or not. The data in different Figures is not coordinated, so the same must be looked at in reference to the particular Figure the data appears in, unless specifically mentioned otherwise. FIGS. 13 through 23 are Screenshots captured from the NYC-HRA Oracle Financials implementation, with real life examples, as entered, tested and demonstrated on the system.

The Specification document first introduces the concepts, and then gradually builds the subject, showing all the technical details involved. It is to be seen in this regard how the underlying concepts and objectives outlined initially in FIGS. 01 and 02 are finally achieved, per detailed custom solution shown in FIGS. 06 through 09 and the brief results thereof shown in FIG. 10. I have described, in the Specification and the Drawings, the subject add-on Controls, comparing and correlating them to the Standard Functionality of the mother system, and showing how the Controls add enhanced utility value, and in the process, also explained, to some limited extent, as needed, the standard functionality. The Specification and Drawings are however intended to explain the add-on functionality of the subject Controls, not for describing the standard functionality of the mother system. For detailed description of the standard functionality, the best source is the published material of Oracle Corporation like the Implementation Guides, Users Guides and Technical Manuals, each of which run into 100s or 1,000s of pages for each module. Similarly, I believe that the published material of other ERP Systems would explain the standard functionality of those systems. I will mail the Oracle Applications Documentation Library consisting of User Guides and Implementation Guides, in Compact Discs, if and as needed by the Patent Office, for processing the application. It is also available for download from the web site of Oracle. Some resources on Oracle's web site may require a MetaLink account.

The two Additional Accounts, 111 DR and 222CR are defined for the purpose of Additional Accounting Effects, as requisites for developing the subject Controls. Two Additional Accounts are defined to meet the requirements of the Double Entry System of Bookkeeping. The subject Controls are applied on 111 DR. 222CR may not have any relevance from a user perspective, but it has its usage value from technical and troubleshooting perspectives. Instead of 111 DR, 222CR, Receipt and Payment (or short forms thereof like RPT and PMT), the Codes could be named any other way, and the nomenclature may or may not fully describe what the Codes do. The Additional Accounts are not to be used for normal user transactions like receipt, invoice and journal. Tables in FIGS. 06 through 09 and Screenshots in FIGS. 17 through 23 show the normal user transactions of invoice and receipt along with the required Additional Accounting Effects when the subject Controls are in place. In the case of AAE1, the appropriate Transaction Code is referenced in the concerned user window. Based on this, the system generates the required journal entry. But in the case of AAE2, the required journal entry is entered. When the subject Controls are fully automated, the system would automatically reference the required Transaction Code and enter the appropriate context-sensitive AAE2, if and as needed, depending on the existing bank funds available and the transaction being processed.

On the HRA implementation, the Controls are so developed that when there is an incoming negative receipt, any funds reserved is undone and Person Hold placed on all pending invoices of the particular Client before processing it, to ensure that the negative receipt is immediately covered, to the extent possible, with the funds so released, and further processing of such invoices, like releasing the hold and revalidation or validation would be done manually, to provide better management of issues or causes specific to HRA. Such minor details can be fine-tuned as needed within the broader framework of the subject Controls. The intent of this Specification is not such minor details of usage value for specific users, but the broader framework in general of the subject invention and how it makes enhanced value addition to the user community across a wide spectrum of ERP Systems users.

### Some Key Terminology Used

It is better to explain the terminology used, and define some of them, as used for the purpose of the subject Controls.
a. Additional Account: Accounts defined for the purpose of additional accounting effects, as part of the subject Controls, not used for normal user transactions.
b. Transaction Code: Account Code Pair, specifying which account is debited or credited, used to create additional accounting effect where the amount of the additional accounting effect is same as the transaction amount. Transaction Code is a standard Oracle Financials feature.
c. Combined Bank Balance: Total of actual balances of all applicable general purpose bank accounts, not set apart for any specific purposes, namely, Savings, Checking 1, Checking 2, etc.
d. Funds Reserved: Funds reserved on prior transactions (like invoice), pending full processing (like payment), if any, irrespective of what intermediate stage they are in (like Encumbrance or Liability). Funds once reserved, cannot be used to cover new transactions, except by way of undoing the prior reservation.
e. Bank Balance Funds Available (or Bank Funds Available, Bank Funds, or BBFA):

The phrase, Funds Available, is generally used to mean the amount still available to spend, out of what is authorized, and normally used with reference to Income Statement items. Oracle Financials uses the phrase accordingly and calculates it using the standard Funds Check formula, Funds Available=Budget−(Actual+Encumbrance), with reference to a code combination. The system so calculates Funds Available for all code combinations. Purely from this perspective, Bank Balance Funds Available is not generally budgeted and calculating Funds Available on bank balance accounts may be inappropriate or not needed. But from a day-to-day user perspective, Funds Available practically means funds still available to spend, in relation to a balancing entity. Bank Balance, a balance sheet item, indicates that it has to do something with the bank balance. Based on these underlying principles, I have defined Bank Balance Funds Available, for the purpose of the subject Controls, as the combined bank balance less funds reserved, if any, still available to spend. BBFA could be positive or negative. It has two components, MBBFA and BBFD, and at any particular time, it will be either MBBFA or BBFD.
f. Modified Bank Balance Funds Available or 111 DR Funds Available (MBBFA or 111 DR FA): While the Additional Accounting Effect 1 maintains the 111 DR Funds Available (calculated per Oracle's standard formula) equivalent to combined bank balance minus funds reserved, if any, the Bank Balance Funds Check Control places absolute control on the 111 DR account, so the 111 DR Funds Available cannot be negative. Accordingly, for the purpose of the subject Controls, 111 DR Funds Available is calculated using the two-part Modified Bank Balance Funds Check Formula, described in Paragraph 0021 under Step 2 (111DR is always=>$0) [0521]. The Modified Bank Balance Funds Available, so calculated, is what the Oracle Financials system, with the subject Controls in place, calculates as Funds Available (per Oracle's standard formula) for the 111DR account. When MBBFA is zero, it means that the BBFA could be either zero or negative. As MBBFA is always zero or positive and negative receipts are accepted by the system even when the existing balance is inadequate, the MBBFA represents the amount available in the system at any time for making outgoing payments, and when it is zero, it means that invoices cannot be paid.
g. Bank Balance Funds Deficit (BBFD): The fact that BBFA can be positive or negative, and the subject Controls require that the MBBFA is always zero or positive, and MBBFA is what the Oracle System displays, we have a scenario when the BBFA is negative and it is not displayed on the system. I have defined this as the Bank Balance Funds Deficit. The Negative Balance Control calculates this when a receipt falls under Scenario 2.21 or 2.22 and puts through the appropriate context-sensitive Additional Accounting Effect 2. BBFD is defined as the Total or Net Deficit on account of Combined Bank Balance and Funds Reserved, if any.

### BIBLIOGRAPHY

Fundamental Financial/Accounting Principles, and Oracle Applications Implementation and User Guides (particularly, Financials)

### SEARCH FOR PRIOR ART

Based on my search, I have not come across any prior art same as the subject invention for the same intended purpose. But I have come across the following prior art, using similar subject matter principles, in different ways, and to different extents, for achieving various objectives in somewhat similar ways:
1. Aggregated Postal Billing and Payment Methods and Systems: Patent Publication: US 2004/0230523 A1
2. Automated Banking Machine System and Method: Patent Publication: US 2007/0235521 A1
3. Electronic Financial Transaction System: Patent Publication: US 2005/0171811 A1
4. Methods, Devices and Systems for Electronic Bill Presentment and Payment: U.S. Pat. No. 6,578,015 B1
5. Systems and Methods for Facilitating a Distribution of Bank Accounts via an Educational Institution patent: U.S. Pat. No. 7,249,096 B1
6. System and Method for Offering Unsecured Consumer Credit Transactions: Patent Publication: US 2004/0225545 A1
7. Computerized Method and System for Managing a Financial Capacity of a Business: Patent Publication: US 2002/0103730 A1
8. Method and System for Enterprise Software having Direct Debit Mandates: Patent Publication: US 2008/0162344 A1
9. Money Fund Bank System: U.S. Pat. No. 6,374,231 B1
10. Financial Transaction Processing Method and System: Patent Publication: International WO 0198957 A2

### Pending Court Case

Certain non-subject matter issues, in relation to the subject invention, are sub-judice, and I will submit the outcome or information in this regard, as the Patent Office may require.

### Related Considerations

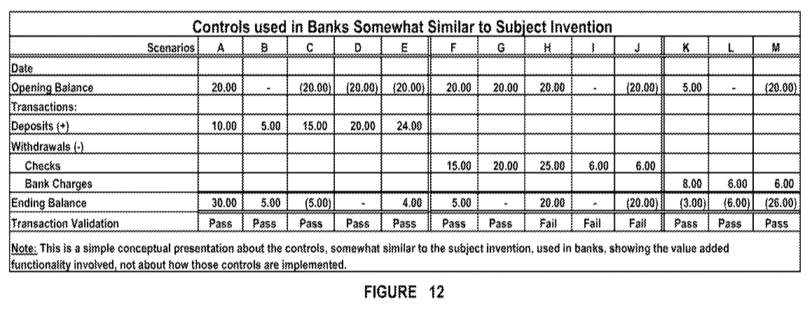

Based on my understanding and knowledge, I believe that my invention is somewhat similar, in some respects, to the controls that organizations like banks use, for various somewhat similar purposes, in different ways that meet their specific needs. FIG. 12 gives a simple-conceptual presentation of how similar controls are used in banks. One day after seeing my Controls working as required, it crossed my mind that my invention could be similar to something used in banks. Then I analyzed the two mentally and understood that there were indeed some similarities. I have not come across any patented or published prior art in this regard.

In the case of banks, when the existing balance is less than the check amount, the check-cashing transaction fails (Scenarios H, I and J in FIG. 12). The bank's automated system thus prevents a check payment resulting in negative balance. On the other hand, when there is a bank charge, that transaction goes through even if it results in or increases the negative balance (Scenarios K, L and M in FIG. 12). Outgoing invoice payment and incoming negative receipt in my invention could be similar to check-cashing and bank charge in the bank scenario. The enhanced usefulness and economic worth of my invention can be understood better when we think of the type of the various risks and costs involved, if all the automated banking machines don't work, all bank customers have to go to the bank for all of their normal banking needs, at the bank also there are no automated controls, and the teller has to manually verify the existing balance and see if it is adequate or not before paying every check presented for payment. Then, if the available balance is inadequate to cover an incoming bank charge, it cannot wait to be processed until there is adequate balance. Any such waiting would have very adverse consequences for the bank and its customer in relation to protection of the latter's assets in this relationship of trust and utmost care, apart from being incorrect presentation of the financial information, and causing adverse ripple effect on subsequent transactions. The right way thus is to process it immediately and adjust any future incoming receipts to first offset the existing negative balance. Thus the need to process the bank charges immediately irrespective of whether or not there is adequate balance to cover the same, and even when they result in or increase the negative balance.

We would appreciate this even better when we think of this in the light of the huge volumes of transactions that the banks process. The same way, when hundreds and thousands of user organizations start using my invention, they will realize more and more the enhanced benefits from my invention. I believe that I am not the right person to say how the banks may have put in place such controls, but do think that they may be having totally custom-made systems specially built for banks with required inbuilt controls, or could be using custom controls on top of the base systems in case those base systems come without such controls. The subject Controls work in similar way and achieve similar objectives, as in the bank scenario.

Apart from the purpose for which the Controls have been developed, I believe that they can be used in many more ways. Apart from the bank example explained, financial services, like banks and credit card companies, can use controls based on similar subject matter principles, to prevent clients from borrowing in excess of their limits, a variety of prepaid businesses can use similar controls to prevent using the service beyond the pre-paid amount or pre-authorized limit, and schools, colleges, universities and a variety of organizations can use similar controls, with minor modifications, as needed, to suit their specific requirements, for a variety of similar objectives. While these are some of the other uses that I can readily think of, there could be many other ways of using the subject Controls in either generic or more specific ways. In brief, the subject Controls will find use, with or without modifications, in all the ERP Systems, Oracle, and non-Oracle, as well as in a variety of other work situations, where needs that are similar or can be considered similar, directly or indirectly, exist, in terms of the underlying fundamental subject matter concepts, in ways that can lead to more efficient work processes, in terms of prevention of risks, better compliance and substantial reduction of costs, in short, a much enhanced overall productivity.

As it is normally the case in any software development or implementation, the same objective can usually be achieved in more than one way. It would depend on factors like the requirements and work environment, whether the development is a totally new system or some add-on features on top of an existing system, and in the latter case, it could also depend on how the base system is designed and built. It will also depend on the approach a particular developer or implementor or inventor uses to visualize, design and build the required features. In the subject case, I initially thought of developing the Controls through total custom programming. Subsequently, I modified my thinking and developed the Controls through a combination of financial, accounting and information systems development principles, assorted existing application features of the mother system and custom programming, to achieve the objectives, based on considerations including process and productivity improvements, workplace efficiencies, prevention of risks, regulatory compliance and cost effectiveness. I also considered the idea of a combined single additional accounting effect, but after considering the various pros and cons, I developed the invention with two additional accounting effects, 1 and 2, as herein described.

Based on my experience and understanding of the market, I believe that many user organizations can and will benefit from the subject Controls, and as such, there is very good commercial potential. Since the subject of this application is the add-on Controls that enhance the standard functionality of the mother system, there is possibility of having, and I intend to have, discussions, in course of time, with Oracle Corporation (and owners of similar non-Oracle ERP Systems like SAP) to integrate the subject high value added Controls as part of their standard application suites, following the usual ERP principles of standardization, flexibility and universal usefulness, in a way they provide enhanced value addition to users across a wide spectrum of sectors, and market as an optional, independent, add-on module, targeting medium and large user organizations that need such additional functionality, at an additional cost. I believe that commercially this could be a good symbiotic relationship on the lines that many small component inventors have worked with Oracle, SAP, Microsoft and other software market leaders, in the past, to integrate their inventions with the mother systems. Marketing the Controls as a stand-alone product for the same purpose is another option. All these and other options are open at this time.

From a user perspective, how the invention provides enhanced utility value over and beyond the prior art and improves the processes and productivity is what is of paramount importance here. While the underlying fundamental subject matter principles are the same in relation to all ERP Systems, how the invention is developed, and how exactly the additional accounting effects are entered or referenced and Controls ensured could differ based on many factors including how the base system is designed and built and the approach the particular inventor follows. I have described herein how I have visualized, designed and developed the subject invention. The subject Controls have the potential to reduce the annual recurring costs substantially, apart from preventing the risks of not having them. When users of ERP Systems find that the system does not meet their specific requirements, they customize the application, as needed. This route is very costly, time-consuming, and regular users cannot normally do it. It normally requires the skills of experienced multi-disciplinary consultants. When the features have universal usage value, as against usage value for a few users, it is better to integrate those features as part of the mother application. This is how I believe the concept of ERP Systems came up, in the first place. In the earlier years, systems were mostly home-developed for the use of specific user organizations. Subsequently, when the principles of standardization, flexibility and universal usefulness came into picture, the user-specific home-grown systems gave way to the ERP Systems, leading to more uniform ways of doing the work and use of best practices across a wide spectrum of users.

I believe that my invention is an improved functionality, process or business method that creates enhanced value addition to the user community. In developing it, I have used existing financial and accounting concepts along with existing Oracle Financials features and custom programming, using the latter to put together the former into a new process, leading to enhanced value addition, like the glue an artist uses to put together the various components of artwork, or cement used to bind the bricks in construction. The value addition comes from the new improved process that puts together the underlying financial and accounting concepts (raw materials), in a way that I visualized, would achieve the intended high value added objectives. I also believe that if and when my invention is integrated with the mother application, it would greatly improve the utility value to the user community, and in turn the market-value, of the mother systems. While I have not figured out, at this time, all the possible uses of my invention, I do believe that it has the potential of finding applied use in more ways than the purpose that I developed it for, like many other inventions have proven in the past.

I first thought of the title Oracle Financials Bank Balance Funds Check and Negative Balance Controls but subsequently changed it to the more generic Bank Balance Funds Check and Negative Balance Controls for Enterprise Resource Planning (ERP) Systems, keeping in mind that the subject add-on Controls would be useful for non-Oracle ERP Systems as well, though developed while working on an Oracle Financials implementation. Some of the leading ERP products worldwide are the Oracle E-Business Suite, PeopleSoft, JD Edwards, SAP, Baan and Great Plains. Oracle E-Business Suite, PeopleSoft and JD Edwards are owned by Redwood Shores, Calif., USA headquartered Oracle Corp., SAP by Walldorf, Germany headquartered SAP AG, Baan by Alpharetta, Ga., USA headquartered Infor and Great Plains by Redmond, Wash., USA headquartered Microsoft Corp. The Oracle E-Business Suite is popularly called Oracle Financials. There are also a host of other ERP products, meeting the needs of different segments of the market.

My income from the HRA project is the first income from this invention.

### Bank Balance Funds Check and Negative Balance Controls as Applicable to Credit and Prepaid Situations

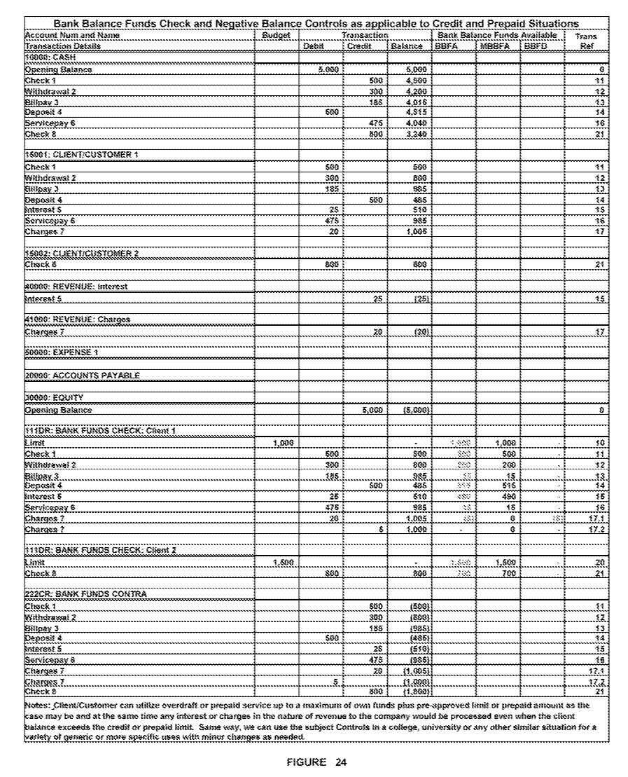

In continuation to Paragraph 0052 hereinabove, the subject Controls can be used in credit and prepaid situations, in which case, a pre-authorized credit limit or prepaid amount (called limit for purposes herein) can be set up, by way of entering such limit or amount, instead of $0, as budget for the 111 DR account and the additional accounting effect 1 or effects 1 and 2, as herein described, to allow the client/customer to use the credit or prepaid service up to a maximum of own funds and the limit. Any transaction in the nature of the client/customer using the credit or service beyond the combined total of own funds and the limit will fail the validation, and at the same time, any interest or service charges that the service provider may charge, in the nature of revenue to the service provider, will be processed even when such transaction results in or increases usage over and beyond the own funds and the limit, as the case may be. The subject controls can also be used in a variety of similar situations, in generic or more specific or applied ways, for similar end-purposes with or without minor changes. FIG. 24 explains how the Controls are achieved in credit and prepaid situations, allowing the client/customer to use credit or service, at any time, up to a maximum of own funds plus the limit. The amount of preauthorized limit or prepaid amount is entered as budget for the 111 DR account (Trans. Ref. 10 for Client 1 and Trans. Ref. 20 fro Client 2), instead of $0 (mentioned in Paragraph 0019). It is to be noted here that had the Servicepay 6 been any amount in excess of $490, instead of $475, that transaction would have failed validation (Trans. Ref. 16). It is also to be noted that while Charges 7 needs both AAE1 and AAE2 (Trans. Ref. 17.1 and 17.2), all other transactions need only AAE1. The Charges 7 transaction (Trans. Ref. 17) of $20 is processed even though the existing bank balance funds available of $5 is inadequate for the transaction and results in negative bank balance funds available. It is to be noted that Trans. Ref. 17 would have failed validation had it been a transaction of client/customer using credit or service instead of being a service charge charged by the service provider.

1) A computer-implemented method, for enterprise financial systems, consisting of a set of controls, that checks if the existing bank balance funds available is adequate for each incoming transaction that requires or impacts such funds, and validates the transaction when there is adequate bank funds available, or fails validation when inadequate; and at the same time, accepts and processes incoming receipts, irrespective of whether or not there is adequate bank funds available to cover any negative receipts, even if resulting in or increasing the existing negative bank funds available, if any, and manages the situation arising there out of, as a result of which, the system prevents negative bank funds available, resulting or increasing, from outgoing payments against invoices, by way of, amongst others, restriction on the standard flexibility of fluctuation between positive and negative amounts, and at the same time, accepts all receipts, positive and negative, by way of, amongst others, context-sensitive exceptions to the restriction; including in situations with or without preauthorized credit limit or prepaid amount as the case may be; the said controls being:

2) the Bank Balance Funds Check Control that checks if the existing bank balance funds available is adequate for the transaction being processed, and

3) validates or fails validation, of transaction, requiring such funds, depending on whether or not there is adequate bank balance funds available for each transaction; and

4) the Negative Balance Control that, acting complementary to and in conjunction with the Bank Balance Funds Check Control, accepts and processes all incoming receipts, even when any negative receipts result in or increase the existing negative bank balance funds available, if any, and manages the situation arising there out of, in relation to:

5) the most normal receipt transactions where the existing bank balance funds available and the incoming receipt are both positive; and context-sensitive exceptions thereto, namely,

6) the existing bank balance funds available is positive, the incoming receipt is negative, and the amount of negative receipt is less than or equal to the existing bank funds available,

7) the existing bank balance funds available is positive, the incoming receipt is negative, and the amount of negative receipt is greater than the existing bank funds available,

8) the existing bank balance funds available is zero or negative, and the incoming receipt is negative,

9) the existing bank balance funds available is zero or negative, the incoming receipt is positive and the amount of positive receipt is less than or equal to the existing bank balance funds deficit, and

10) the existing bank balance funds available is zero or negative, the incoming receipt is positive and the amount of positive receipt is greater than the existing bank balance funds deficit;

11) the Bank Balance Funds Available, or Bank Funds Available, being defined for the purpose herein, as the combined bank balance, to the extent not set apart for any specific purposes or reserved on prior transactions and still available to spend on future transactions, that at any particular time, could be either Modified Bank Balance Funds Available, or Bank Balance Funds Deficit;

12) the Modified Bank Balance Funds Available being defined as the amount of bank balance funds available when it is positive, as available to cover outgoing payments against invoices; and

13) the Bank Balance Funds Deficit being the amount of bank balance funds available when it is negative, defined as the Total or Net Deficit on account of the combined bank balance and the Funds Reserved, if any; and

14) the subject Controls being achieved by way of defining two Additional Accounts, the first of which is subjected to absolute funds check and so controlled as required to maintain its standard Funds Available equal to the combined bank balance less funds reserved, if any, when the same is positive, or equal to zero when it is zero or negative, such requirement for the purpose herein being defined as the Modified Bank Balance Funds Check and the said standard Funds Available so calculated on the said first of the two additional accounts subject to the requirement herein described being the Modified Bank Balance Funds Available defined in claim 12, and entering Additional Accounting Effect or Effects, using the said two additional accounts, for all user transactions that require or impact the bank balance funds available, so appropriately required, as to so maintain the said modified bank balance funds available at the said equal to or greater than zero level, depending on the existing bank funds available and incoming transaction details, in such a way as to perform the enhanced value added functions vide claim 1, read with claim 2 in relation to all transactions, read with claim 3 in relation to outgoing payments against invoices, and read with claims 4 through 10, in relation to incoming receipts including context-sensitive exceptions thereto and the context-sensitive treatment so required to manage the situation arising there out of, and

15) the said Controls can be used in credit and prepaid situations, by entering a preauthorized limit or prepaid amount (called limit, for purposes herein), in addition to additional accounting effect or effects, to allow the client/customer to use the credit (like overdraft or revolving credit) or prepaid service up to a maximum of own funds and the limit, in which case, any transaction in the nature of the client/customer using the credit or service beyond the combined total of own funds and limit will fail the validation, and at the same time, any interest or other charges as the service provider may charge, will be processed even when such transaction results in or increases usage in the client account over and beyond the said own funds plus limit, and in a variety of similar situations, in generic, specific or applied ways, for similar end-purposes, as needed, as the case may be, with or without any other minor changes, parameters or variations, like margin or retention, within the objectives herein, namely, allowing transactions up to a particular predefined requirement, in relation to bank balance funds available, and preventing transactions that fail to meet that requirement, and at the same time, allowing transactions as need-based exceptions even when the said requirement is not met.
